(19) United States
(12) Patent Application Publication
(10) Pub. No.: US 2021/0285262 A1
(43) Pub. Date: Sep. 16, 2021

(54) Beach Security

(71) Applicant: Mark SZRENKO, Tarneit, Victoria (AU)

(72) Inventors: Mark SZRENKO, Tarneit, Victoria (AU); Giles MATTHEWS, Camberwell, Victoria (AU)

(21) Appl. No.: 17/255,695

(22) PCT Filed: Jun. 26, 2019
(86) PCT No.: PCT/AU2019/050661

§ 371 Date: Dec. 23, 2020

(30) Foreign Application Priority Data
Jun. 27, 2018 (AU) 2018902315

(51) Int. Cl. E05B 73/00; E05B 67/38; E05B 67/02

(52) U.S. Cl. CPC E05B 73/0005; E05B 67/02; E05B 67/383

(57) ABSTRACT

A locker (1) including a lockable compartment (3) and an anchor (5). At least a portion of the compartment is tapered to penetrate particulate. The anchor is below the compartment and rotatable to pull the compartment at least partly into the particulate.

### FIELD OF THE INVENTION

Methods and apparatus for securing valuables when visiting the beach are disclosed. Some variants of the technologies disclosed herein may be applied in other contexts.

### BACKGROUND TO THE INVENTION

At least in Australia, it is commonplace to visit a sandy beach and to enter the water to surf or swim, or to otherwise enjoy the water. Whilst enjoying the water it is customary to leave one's valuables (e.g. car keys and mobile phone) on the beach.

This leaves beach-going bathers as easy targets for thieves and unfortunately it is not uncommon for unattended valuables to be stolen, particularly in the context of a crowded beach where thieves can go unnoticed in the crowd.

Accordingly, preferred forms of the invention aim to provide improvements in and for security on a sandy beach or at least to provide the public with a useful alternative.

### SUMMARY

One aspect of the invention provides a locker including

a lockable compartment; and

an anchor;

at least a portion of the compartment being tapered to penetrate particulate; and

the anchor being below the compartment and rotatable to pull the compartment at least partly into the particulate.

Preferably the locker includes a handle for rotating the anchor. Most preferably the compartment is capable of receiving, to lock away, at least a portion of the handle to impede unauthorised unscrewing of the anchor.

The handle may be reconfigurable between

a first configuration for rotating the anchor; and

a second configuration in which the at least portion of the handle is configured for receipt, and locking away in, the compartment.

The handle may be longer than the compartment is wide.

Another aspect of the invention provides a locker including

a lockable compartment;

an anchor connected to the compartment; and

a handle
for rotating the anchor to screw the anchor into particulate;
longer than the compartment is wide; and
reconfigurable between a first configuration, for rotating the anchor, and a second configuration in which the at least portion of the handle is to configured for receipt, and locking away, in the compartment to impede unauthorised unscrewing of the anchor.

The handle may include parts

mutually connectable for the first configuration and

mutually disconnectable for the second configuration.

The parts may include

a hub mounted, or mountable, coaxial to the anchor; and

two handle portions connectable to, for rotating, the hub.

The locker may include at least one tie tying the parts together and being resiliently extensible to enable the parts to be mutually disconnected to form the second configuration.

Preferably the handle is, or is positionable, above the compartment. The locker may include a shaft for transmitting torque from the handle above the compartment to the anchor.

Optionally the anchor is hollow and has an inlet. The shaft and the anchor may include features shaped to enable the shaft to be moved, relative to the anchor, between

a storage position in which the shaft is receivable within the anchor for storage; and

a transmission position for transmitting torque.

Preferably the shaft has

a first end configured to engage, to transmit torque to, the anchor; and

a second end configured differently, to the first end, to pass through the inlet to enable the shaft to move into the anchor for storage.

The anchor may be retractable for storage. The anchor may be telescopic, or otherwise length-adjustable.

Optionally an exterior of the compartment is round to impede the application of torque thereto. Preferably the compartment is capable of rotation relative to the anchor to impede unauthorised reversal of the anchor. The compartment may be capable of pivoting about horizontal axes relative the anchor to impede loosening the anchor by applying horizontal force to a top of the compartment. Most preferably one of the compartment and the anchor defines a spherical surface co-operable with the other of the compartment and the anchor.

Optionally the compartment has an exterior and a top; and

below the top, at least most of the exterior is tapered.

The locker may have a pivotally mounted lid. The locker may include a lock for locking the compartment.

Preferably an outer extent of the anchor is at a diameter not less than half a width of the compartment.

Another aspect of the invention provides an anchor, extensible from a collapsed configuration to an operative configuration, comprising

a telescopic shaft comprising
a first shaft portion; and
a second shaft portion mounted to slide relative the first shaft portion;

a first driving arrangement carried by the first shaft portion and shaped to pull into particulate when rotated above an axis of the shaft; and

a second driving arrangement carried by the second shaft portion and shaped to pull into particulate when rotated above an axis of the shaft.

Preferably the first driving arrangement and the second driving arrangement are each helical. Most preferably they are coils. Optionally, the second driving arrangement is arranged to screw into, so as to helically interlock with, the first driving arrangement when the anchor is collapsed to the collapsed configuration.

A locker may have the anchor.

The locker preferably includes a lock for locking the compartment.

The locker may comprise an eye through which a shackle of a padlock is passable to lock the compartment. Preferably the locker comprises a cover for covering the eye and the padlock. The padlock may comprise a body. The shackle may comprise an outward run running outwardly from the body, an inward run having an end reversibly receivable in the body, and an outer shackle portion connecting the outward run to the inward run.

The locker may comprise
a stop;
a restraint;
an outer-installation space forward of the eye and rearward of the restraint;
an inward-installation space through which the inward run is movable to engage the eye;
a body-installation space adjacent the stop to receive a portion of the body as the outer shackle portion is moved, whilst the inward run remains engaged with the eye, into the outer-installation space;
a shackle-receiving space under the restraint and positioned to receive the shackle when the padlock is advanced from the body-installation space;
a body-receiving space positioned in front of the stop for a portion of body to pivot, after said advancement and about the outer-run, into the body-receiving space;
the restraint being at a distance, less than a locked-length of the padlock, from the stop such that, when the padlock is locked after said pivoting, the shackle is trapped behind the restraint and the body is trapped in the body receiving space.

Preferably the locker comprises guarding portions positioned to run alongside the inward run and the outward run.

Another aspect of the invention provides a set comprising the locker and the padlock.

Another aspect of the invention provides a locking device co-operable with a padlock;

the padlock comprising
a body; and
a shackle;

the shackle comprising
an outward run running outwardly from the body;
an inward run having an end reversibly receivable in the body; and
outer shackle portion connecting the outward run to the inward run; and

the locking device comprising
an eye;
a stop;
a restraint;
an outer-installation space forward of the eye and rearward of the restraint;
an inward-installation space through which the inward run is movable to pass through the eye;
a body-installation space adjacent the stop to receive a portion of the body as the outer shackle portion is moved, whilst the inward run remains through the eye, into the outer-installation space;
a shackle-receiving space under the restraint and positioned to receive the shackle when the padlock is advanced from the body-installation space; and
a body-receiving space positioned in front of the stop for a portion of body to pivot, after said advancement and about the outer-run, into the body-receiving space;
the restraint being at a distance, less than a locked-length of the padlock, from the stop such that, when the padlock is locked after said pivoting, the shackle is trapped behind the restraint and the body is trapped in the body receiving space.

Another aspect of the invention provides a method of installing a locker;

the locker including
a lockable compartment, and
an anchor below the compartment;

the method including turning the anchor to pull the compartment at least partly into particulate.

Another aspect of the invention provides a method of installing a locker;

the locker including
a lockable compartment,
an anchor; and
a handle longer than the compartment is wide;

the method including
turning the handle to screw the anchor into particulate; and
locking away, at least a portion of the handle, in the compartment to impede unauthorised unscrewing of the anchor.

Preferably the particulate is sand.

### BRIEF DESCRIPTION OF DRAWINGS

FIG. 1 is a partially exploded view of a locker;

FIG. 2 is an elevation of the locker with its anchor both deployed and in its shortest configuration;

FIG. 3 is an elevation of the locker with its anchor both deployed and in its intermediate-length configuration;

FIG. 4 is an elevation of the locker with its anchor both deployed and fully extended;

FIG. 5 is a vertical cross-section view of the locker in its transport configuration;

FIG. 6 is a vertical cross-section view of the locker in its installation configuration;

FIG. 7 is an enlargement of detail A in FIG. 6;

FIG. 8 is a partially exploded view of an anchor;

FIG. 9 is a top perspective view of a retainer;

FIG. 10 is a bottom perspective view of a handle-hub;

FIG. 11 is a plan view of a lid;

FIGS. 12 to 15 are section views corresponding to lines A-A, B-B, C-C and D-D in FIG. 11;

FIG. 16 is a vertical cross-section view of another locker in its installation configuration;

FIG. 17 is an elevation of a ground anchor;

FIG. 18 is an elevation of a locker;

FIG. 19 is an elevation of an anchor;

FIG. 20 is an elevation of an installed anchor; and

FIG. 21 is an elevation of the anchor of FIG. 19 when installed.

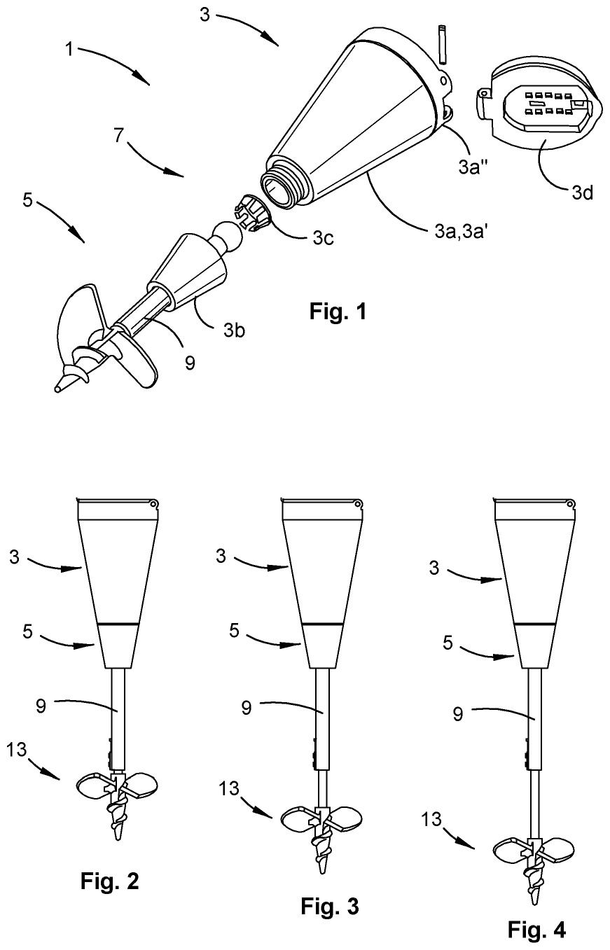

### DETAILED DESCRIPTION

The locker 1 incorporates a lockable compartment 3, an anchor 5 and a connection arrangement 7 connecting the compartment 3 to the anchor 5.

The locker 1 is intended for use on a sandy beach but may be usefully applied in the context of other particulates, e.g. in the context of soil. Indeed, other variants of the technology may be better suited to such other particulates.

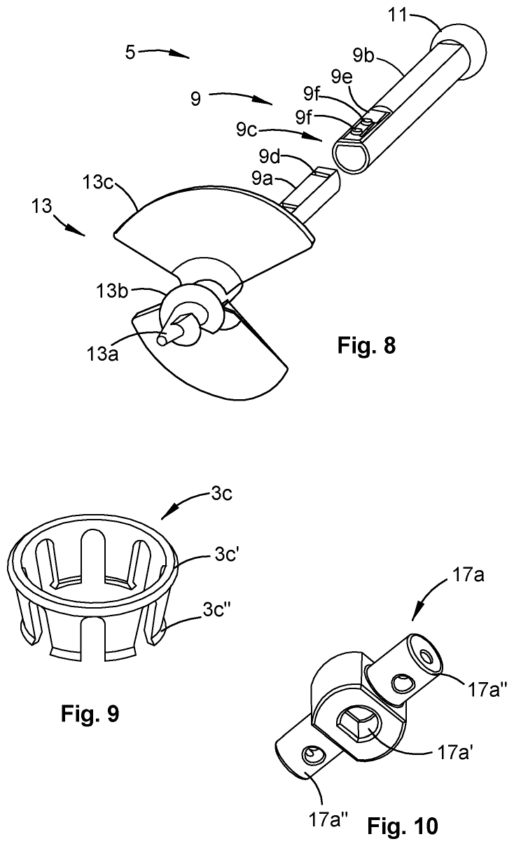

The anchor 5 includes a telescopic mechanism 9 extending downwardly from a ball 11 to a drive member 13 (FIG. 8). The anchor 5, or more specifically the drive member 13, is rotatable to pull into the sand. The drive member 13 is an integral body of material, although multi-part constructions are also possible.

As used herein, ‘integral’ and similar wording refers to formation from a continuous body of material—components may be integrated by welding but not by typical mechanical fastening.

The drive member 13 includes a central conical body 13a about which a thread-like convolution of material is wrapped to form a threaded portion 13b. The member 13 further includes a pair of blades 13c sitting above the threaded portion 13b.

The point of the conical body 13a is configured to stab into the sand like a spearhead whilst the following threaded portion 13b assists with the initial engagement of the anchor into the sand before the blades 13c engage the sand more securely.

Other forms of anchor are possible. By way of example one of the threaded portion 13b and the blades 13c might be omitted. Indeed, even a simple screw-like auger section or a simple helical coil of material are contemplated.

Telescopic mechanism 9 includes an inner element 9a and an outer element 9b into which the inner element is slidingly receivable. Each of the elements 9a, 9b has a respective substantially constant profile and as such is well adapted to formation by extrusion followed by subsequent machining operations. In this example, the profiles are hollow, aluminium and mostly round but for respective flats.

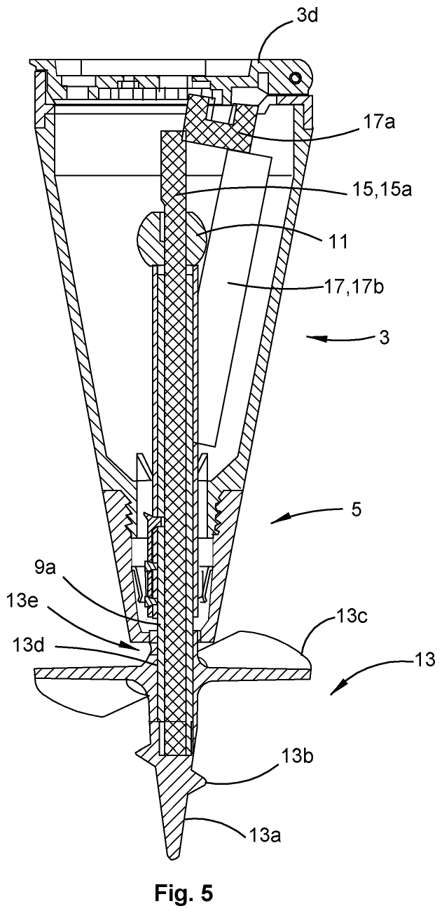

The drive member 13 incorporates an upwardly open socket 13d (FIG. 5) for receiving a lower end of the inner element 9a. The anchor further includes a side hole 13e opening into the socket 13d and by which the element 9a is securely connected to the member 13. Other modes of connection are possible.

The telescopic assembly 9 incorporates a detent 9c for stopping the mechanism at distinct lengths, in this case at three distinct lengths corresponding to the short, medium and long configurations of FIGS. 2, 3 and 4 respectively. The flat of the inner element 9a is penetrated by detent holes 9d spaced along its flat. In this example there are three detent holes corresponding to the three selectable lengths.

A latching member 9e is bolted to the flat of the outer element 9b via bolts 9f. The latching member 9e includes a detent projection 9g arranged to pass through a complementary opening through the flat of the outer element 9b to engage one of the detent hole 9d.

The latching member 9e is formed of a suitable resilient material (such as glass filled polyamide) and incorporates a user manipulable portion 9h by which the element 9e is resiliently deformable to withdraw the projection 9g from the opening 9d to enable the elements 9a, 9b to slide relative to each other until a projection 9g moves into register with another of the openings 9d whereat the projection 9g moves under its own bias into the other opening 9d to retain the orientation corresponding to that other opening. Other forms of detent mechanism are possible.

The ball 11 sits at the top of the element 9b. In this case the ball is aluminium and welded to the top of the element 9b. The ball 11 is spherical but for a flat top and bottom surfaces and a vertical through-bore. The vertical through-bore has a complex shape. The lower half has a D profile closely corresponding to the internal profile of the inner element 9a. The top half of the ball's through-bore has a square profile although other non-round shapes are possible.

The locker 1 includes a drive shaft 15 most of which has a D-shaped profile complementary to the interior of the element 9a and the lower half of the ball 11 whereby the ball 11 defines an inlet through which the shaft 15 is receivable into the anchor 5 for storage. In this example of the locker 1 the shaft 15 extends through and beyond the ball 11 and the telescopic assembly 9 and into an end portion of the socket 13d within the body 13a.

An end 15a of the shaft 15 is the top end in the transportation configuration of FIG. 5. The end 15a has a square profile complementary to the square profile of the ball 11 whereby when removed from the anchor 5 the shaft 15 is reversible to engage the end 15a with the ball 11 whereby a torque-transmitting connection between the components 11,15 is formed. Non-round profiles other than square are possible. Indeed, other forms of torque-transmitting connection are possible.

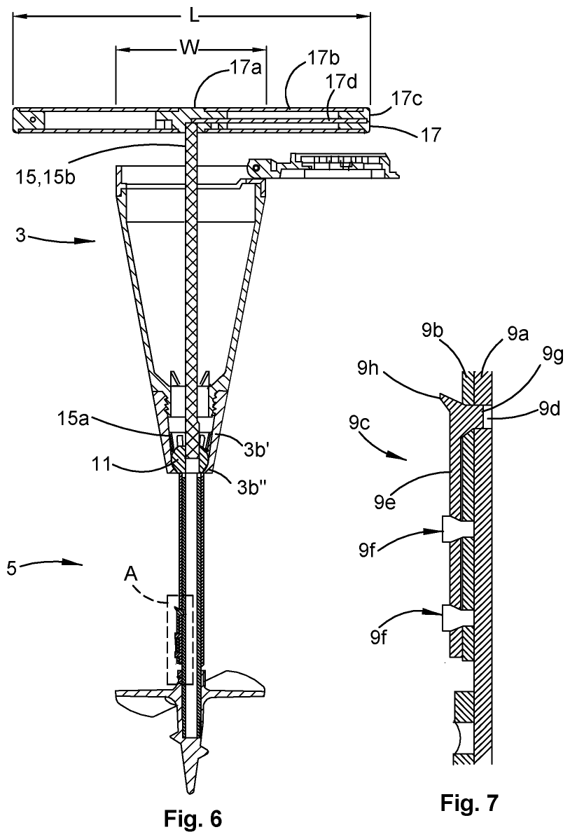

When the shaft 15 is oriented to engage the ball 11 (as in the installation configuration of FIG. 6) the other end 15b of the shaft sits above the compartment 3 to cooperate with a handle 17 by which the shaft, and in turn the anchor 5, is rotatable.

In this example of the locker 1, the anchor 5 is not only telescopically extendible but also reversibly extendable from the container 1. In the transport configuration of FIG. 5 the anchor 5 sits retracted into the compartment 3. In the installation position of FIG. 6 the anchor 5 sits extended from the compartment 3.

The compartment 3 incorporates a main body 3a, a lower body 3b, a retainer 3c and a lid 3d. Preferably the components 3a, 3d are at least predominantly formed of a suitable plastic such as polycarbonate or ABS.

The main body 3a has an approximately frusto-conical form including a downwardly-tapering conical wall and an externally threaded tubular boss downwardly projecting from its lower end. In this example the main body 3a is a weldment of a conical cup 3a′ and rim 3a″. The parts 3a′, 3a″ are mutually fastened by ultrasonic welding. The rim 3a″ defines a short cylindrical exterior.

The lower housing 3b is another hollow frusto-conical piece open at each of its ends. A top end of the lower body 3 defines an internally threaded socket co-operable with the lower end of the main body such that, when these components are brought together, the lower body extends the main body's conical surface. The lower body 3b is preferably formed of a suitable rigid material, e.g. plastic such as glass-filled polyamide.

An inwardly directed annular groove 3b′ circumscribes an interior of the lower body 3b about half way up that body's height.

The retainer 3c is another resilient glass-filled polyamide piece. Other resilient materials may well be practical.

The retainer 3c includes a circular rim 3c′ by which the retainer 3c can be clicked into the annular groove 3b′ within the lower body 3b. The retainer 3c further includes resilient fingers 3c″ downwardly extending from the rim at a shallow inward inclination (i.e. at a small angle from vertical towards the central axis of the locker 1). Each of the fingers terminates in a respective short end portion at a shallow outward inclination.

The lower body 3b includes at its lower end bearing surfaces 3b″ for bearing against the ball 11. In this example the bearing portions 3b″ are spherical for a conformal fit with the ball 3b.

When the anchor 5 is pushed downwardly from the storage configuration to the installation configuration (i.e. from FIG. 5 to FIG. 6) the ball 11 is pushed through the retainer 3c causing the fingers of the retainer 3c to resiliently outwardly deform. The bearing surface 3b″ is configured to receive the ball 11 so that the fingers (or more specifically their out-turned end portions) remain in contact with a top half of the ball 11 and thereby urge the ball 11 into contact with the bearing surfaces 3b″.

This example of the arrangement 9 is a spherical-pivotal connection formed between the compartment 3 and the anchor 5 akin to a rose joint. The joint allows relative movement up to about 30° from vertical.

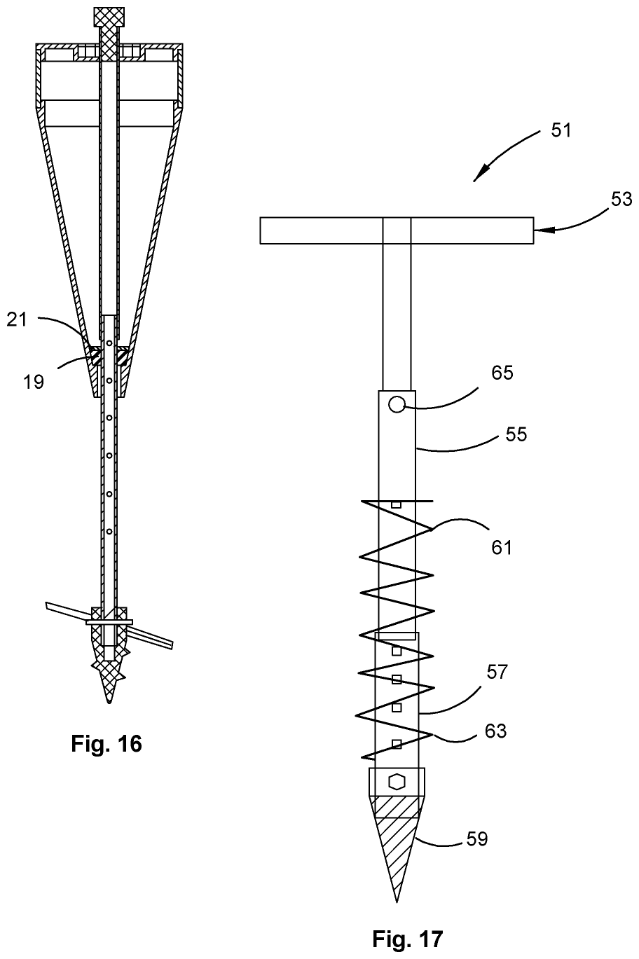

FIG. 16 illustrates an alternative locker in which the rose-joint-like connection is replaced by a rubber bushing 19. In this case, the bushing 19 is topped by a compliant washer 21. Other flexible connections, to enable relative movement between the anchor and the compartment, are possible.

The handle 17 incorporates a hub 17a (FIGS. 6 and 10), two tubes 17b, two end pieces 17c and a pair of ties 17d. The hub 17 incorporates a D-profile socket 17a′ for receiving and engaging the end 15b of the shaft 15. Other forms of torque-transmitting connection are possible.

The hub 17a further includes a pair of spigots 17a″ onto which the inner ends of the tubular portion 17b are fittable. End pieces 17c are fitted to the outer ends of the tubular portion 17b whilst each of the ties 17d ties a respective one of the end pieces 17c to the hub 17a.

When assembled (as in FIG. 6) the handle has a length longer than the width of the container 3. In this case the handle is more than twice as long as the container is wide.

As variants of the terminology are used herein, the width of the compartment is the compartment's longest horizontal dimension when installed. In this example, the width corresponds to the largest diameter of the conical exterior.

The provision of a long handle enables greater torque to be applied to the anchor 5 to enable the anchor to be screwed deeper and more securely into the sand.

The hub 17a is releasably connected to the top of the shaft 15 whereby once the anchor has been screwed in the handle 17 can be simply lifted away. The ties 17 are elastic, e.g. are elastic bungy cords that can be stretched to disengage the tubes 17b from the spigot 17a″ whereby the handle is conveniently collapsible to a storage configuration compact relative to the handle's long configuration of FIG. 6. In its collapsed configuration the handle 17 is conveniently stowable within the compartment 3.

The locker 1 incorporates one example of a reconfigurable long handle. Other forms of reconfigurable long handle are possible. Indeed, another variant of the locker may incorporate a long handle in the form of a simple integral rod securable within a compartment having a suitable internal height to external width ratio.

The lid 3d includes a plastic body carrying a combination lock (not shown). The body 3d is pivotally mounted to the rim 3a″ and the lock incorporates a latching body engageable with the rim 3a″ whereby the compartment 3 is a lockable compartment. Other forms of lock are possible. Indeed, a compartment may be made lockable by the provision of a pair of aligned apertures with which a padlock is co-operable, although preferred variants of the locker 1 incorporate a lock.

FIG. 11 illustrates a lid 3d′ equipped with a locking device co-operable with a padlock 25 to lock a compartment. The padlock 25 comprises a body 27 and a shackle 29. The body 27 has a shape approximating a right-hexahedron with an aspect ratio L:W:D of about 6:2:1.

The shackle 29 projects from the forward end of the body 27 (i.e. the end towards the left-hand side as drawn in FIG. 11) and comprises a metallic loop having an outward run 29a (extending outwardly from the body 27), an inward run 29c (running towards the body 27) and an outer portion 29b mutually connecting the runs 29a, 29c.

The padlock 25 is a combination-type padlock comprising thumb wheels (not shown) accessible from above the lid when the padlock 25 is installed in the device 23 (i.e. as illustrated in FIG. 11). When the correct combination is entered via the thumb wheels, the shackle 29 is propelled outwardly in the forward direction (to the left as drawn in FIG. 11) to free a free end of the inward run 29c from the body 27.

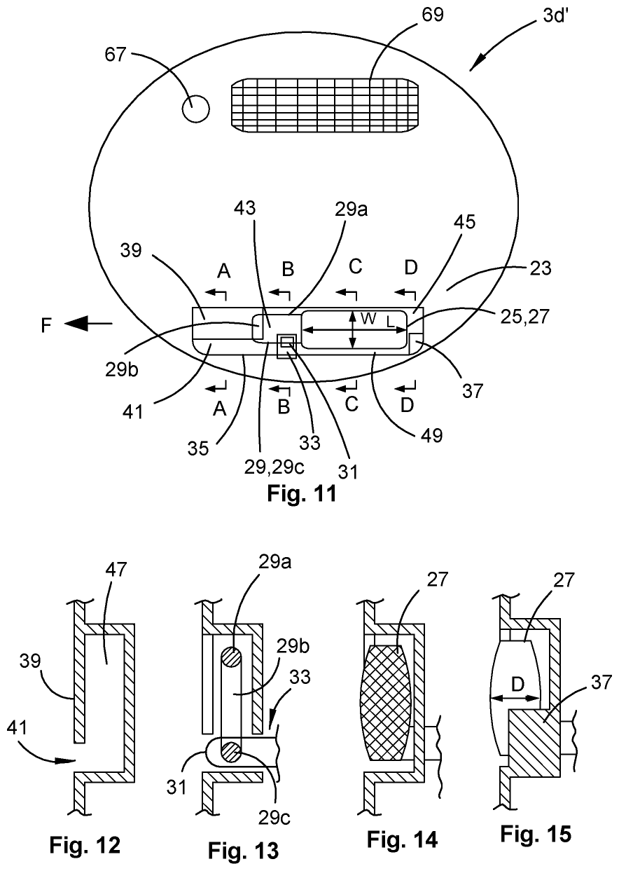

The locking device 23 comprises an eye 31 securely fixed to the body 3a (not shown in FIGS. 11 to 15). The eye 31 passes upwardly through an opening 33 through the lid 3d′. In this example, the locking device 23 comprises an elongate, upwardly-open recess 35. When the lid is closed, the eye 31 sits within the recess 35. The locking arrangement further comprises a stop 37 at one side of a rear end of the recess 35, and a restraint 39 which in this particular example takes the form of a cover plate.

To install the padlock 25, the padlock is first unlocked and the shackle 29 is pivoted, through about 180°, relative to the body 27 to a configuration at which the free end of the inward run 29c is away from the body 27. The eye 31 is positioned adjacent one side of the recess 35. The restraint 39 extends from the other side of the recess and spans only part of the width of the recess 35 leaving an inward installation space 41 in register with the eye 31 and into which the inward run 29c can be lowered and pulled back to engage the eye 31.

The eye 31 and restraint 39 bracket an outer-installation space 43. The stop 37 projects part-way across the width of the recess 35 and from the same side of the recess 35 as the eye 31, thus leaving a body-installation space 45 adjacent the stop 37.

After the inward run 29c is passed through (i.e. engages) the eye 31 (i.e. after a first phase of installation), the padlock 25 can be manipulated. During this second phase of operation, the shackle is pivoted about its inward run 29c through about 90° whilst the body 25 is pivoted through about 90° relative to the outward run 29a. During this second phase, the outer portion 29b is lowered into the outer installation space 43 whilst a rearward corner of the body 27 is lowered into the body-installation space 45. In this intermediate position, the shackle 29 lies flat in the recess 35 whilst the body 27 sits side-on such that its width-wise direction W is about normal to the floor of the recess 35.

From this intermediate position the padlock 25 is advanceable to move the outward run 29b into the shackle-receiving space 47 under the restraint 39. The same movement brings the body 27 into register with a body-receiving space 49 that is bracketed by the stop 37 and the eye 31. Of course, ‘under’ in this context is understood as in ‘behind’. Whilst the locking device 23 is illustrated in plan in FIG. 11, it would work just as well in any other orientation, e.g. if the device was reoriented so that FIG. 11 was an elevation view.

The body 27 can then be pivoted through about 90° about the outward run 29a so that the body 27, like the shackle 29, sits flat in the recess 35. Via the inner installation space 41, a user can access the shackle 29 to push it back into the body 27 and thereby lock the padlock.

The lengthwise separation of the stop 37 and the restraint 39 is less than the locked length of the padlock 25 whereby, in this locked configuration, the shackle 29 remains trapped under the restraint 39 whilst its inward run remains captured in the eye 31. The stop 37 prevents the padlock 25 being reversed so as to clear the restraint 39.

The padlock is thus held flat within the recess 35 whereat side walls of the recess serve as guarding portions to guard the shackle 29. In particular, the locking arrangement 23 serves to impede access to the padlock with tools such as bolt cutters and screwdrivers (and other convenient levers) that thieves might use to break through the padlock.

Other variants of the device 23 are possible. By way of example, whilst in this variant the restraint 39 takes the form of a cover plate, in another variant the restraint might take the form of a finger projecting from a wall of the recess 35 to overlie the outward run 29a. In this example, the side walls of the recess 35 also constrain the movement of the padlock 25 about the eye 31. Other forms of constraint are possible, e.g. the eye 31 might be tubular and closely conform to the inward run 29c. The locking arrangement 23 leaves a major face of the padlock 25 exposed whereby the thumb wheels (or other user-manipulable portions) can be accessed. Other variants of the locking arrangement may be configured to co-operate with padlocks having a keyhole in their rear face, e.g. the stop 37 may be shaped to clear the keyhole.

The lid 3d preferably further includes a cover, e.g. a pivotally-mounted cover, that fits over the locking device 23 to keep it and the padlock 25 free of sand.

The locking device 23, and variants thereof, can be employed in contexts other than lockers akin to the locker 1. Indeed, locking device 23 may be advantageous in most contexts where a padlock is called for.

The locker 1 has an overall length in the vicinity (say within 50 mm of) 360 mm. When the anchor 5 is extended from the compartment 3 to its deployed position (e.g. as in FIGS. 2 and 6) the overall length is in the vicinity of 510 mm. Preferably the detent holes 9d are spaced at 50 mm centres whereby the configurations of FIGS. 3 and 4 have an overall length in the vicinity of 560 mm and 610 mm respectively.

A preferred mode of utilising the locker 1 entails arriving at a site having particulate, e.g. at a beach, with the locker 1 in its transport configuration. The drive member 13 can be grasped to pull the anchor out to its deployed configuration. Upon reaching that configuration the user will feel the ball 11 click into place under the fingers of the retainer 3c.

The user may also telescopically extend the anchor assembly, e.g. based on an assessment of the particulate and/or on an assessment of the risk and/or valence of theft and/or on an assessment of the user's strength. By way of example, in very hard dense sand on a deserted beach and where goods of only a low value are to be stored, the configuration of FIG. 2 may be ample. In other contexts (such as loose sand, a high crime area and high value items to be stored) the anchor might be fully extended to the configuration of FIG. 4 for better anchorage, albeit that this may entail additional work to install the locker 1.

With the length of the anchor selected the compartment 3 may be unlocked and the handle 17 withdrawn therefrom. In this example, substantially all of the handle is packed away for security although in other variants of the concept only certain key portion(s) of the handle might be locked away. By way of example, the hand-contacting portions (the tubes 17b in this case) might be locked away whilst some variant of the hub 17a remains exposed through a suitable hole in the lid 3d.

Once the components of the handle 17 have been accessed and reconfigured the shaft 15 can be withdrawn from the anchor 5 and reversed to engage the end 15a with the ball 11. The handle 17 can then be engaged with the end 15b of the shaft 15.

The user may then press the spearhead-like end of the portion 13a into the sand and begin turning the handle to screw the drive portion 13 into the sand.

With ongoing turning of the handle 17 the compartment 3 may be drawn into the sand, preferably until at least most (or more preferably substantially all) of the compartment is not higher than the free surface of the sand, e.g. the locker may be screwed in until its top is flush with the sand.

A preferred mode of installation entails screwing the drive portion 13 into the sand a short distance and then pulling it out to dig a hole. This process might be repeated until the hole is commensurate in size to the compartment. Thereafter the drive portion can be turned to engage deep down into the sand and pull the compartment into the hole. These initial operations to dig the hole are akin to pre-drilling a screw hole. They serve to make it easier for the tapered compartment to penetrate the sand, and easier for the anchor to pull the compartment into the sand.

With the compartment 3 installed in the sand the handle 17 can be collapsed to its compact configuration and returned to the interior of the compartment and the shaft 15 can be reversed and returned to the interior of the anchor 5. Valuables to be stored such as keys, a wallet and a phone can then be left in the compartment and the lid 3d closed and locked to lock away the handle 17 and the valuables.

The locker 1 may then be fully concealed with a few additional handfuls of sand and/or placed under a beach towel. The locker is thus hidden away to avoid attention from thieves. Moreover, even if thieves were to discover the locker, the locker is configured to make unauthorised access and/or removal difficult.

The tapered exterior of the compartment 3 enables it to be pulled into the sand whereby it is difficult to access to apply any force to. The anchor, or more specifically the drive portion 13, is deeper still in the sand.

The compartment's exterior is preferably at least mostly round, coaxial to the anchor 5 and smooth whereby it is difficult to apply an unscrewing torque to the exterior of the compartment. Revolved shapes other than conical are possible.

In any case, in this preferred variant of the locker 1 the connection 7 forms a pivotal connection about which the compartment 3 is rotatable about the anchor's screwing axis. As such, even if a thief were to apply torque to the exterior of the compartment, the compartment would simply free wheel upon the anchor without unscrewing the anchor.

In this particular example, the joint 7 is a spherical joint whereby even if a thief were to dig out sufficient sand to enable the top of the compartment 3 to be moved laterally that movement would do very little to loosen the anchor.

As noted, the anchor 5 and in particular drive member 13 can take a variety of forms. In this example the drive member 13 has a functional diameter (corresponding to the outer diameter of the blades 13c) at least commensurate (i.e. not less than 80% of) the width W of the container. The large driving portion results in a secure engagement with the sand making it very difficult for a thief to withdraw the anchor without digging out a great deal of sand.

The long handle 17 allows users of limited strength to turn the large anchor into the sand. This long reconfigurable handle and variants thereof could be usefully applied in the context of lockers wherein the compartment does not penetrate the sand.

Some variants of the locker may incorporate an alarm configured to trigger in response to an unauthorised attempt to access the locker. FIG. 11 illustrates a variant of the locker comprising a visual indicator in the form of LED 67 to convey information on the alarm function to a user. By way of example, the system might be configured to alarm for a period of time after a triggering event and thereafter the LED 67 might blink to inform the owner of the locker that a triggering event occurred whilst they were away. Other visual indicators are possible. The alarm might be an audible alarm and for this purpose the locker may be equipped with a speaker 69.

The triggering event might be related to movement, e.g. in response to movement in combination with a failure to deactivate the alarm within a defined period of time. The alarm might be deactivatable by entering a code and/or by interacting with the interface accessible only after unlocking the compartment. For this purpose, the locker per se may comprise an accelerometer. Alternatively, it might incorporate simple electronics configured to co-operate with a mobile phone (e.g. an iPhone) so as to take advantage of the sensors incorporated into the phone. The electronics of the alarm might be mounted on a circuit board on the back of the lid.

The locker 1 may also serve as a convenient anchor point for other items to be secured. By way of example, a tether may be equipped with a loop engaging the telescopic assembly 9 but not so large as to enable the loop to be lifted past the compartment 3. Optionally, the locker may be equipped with an eye (e.g. a hole through the shaft) or other point of connection for such tethers. Indeed, compartment-less variants of the technology disclosed herein may be employed as land anchors to secure such tethers or to otherwise bear loads.

FIG. 17 illustrates a compartment-less land anchor 51 comprising a handle 53, a top element 55 and a bottom element 57. The top element 55 is a cylindrical tube as is the bottom element 57. The bottom element 57 fits over the tube 55 to slide therealong. The elements 55, 57 thus together constitute a telescopically extendable shaft. A detent arrangement (not shown) enables the shaft to hold its extended and collapsed lengths. A ground-penetrating spearhead 59 caps the lower end of the element 57. The top element 55 carries a driving arrangement 61 whilst the bottom element 57 carries a driving arrangement 63. Whilst the arrangements 61, 63 might take any convenient form, such as the bladed form of the drive member 13, they preferably take the form of helical coils. In this example, the arrangements 61, 63 are helical coils with the same pitch and diameter as each other. A top of the drive arrangement 61 is fixed relative to the top element 55 whilst a bottom of the drive arrangement 63 is fixed to the bottom element 57.

A button detent mutually fixes the elements 55, 57 when the shaft 55, 57 is extended. Other modes of fixation are possible. When the detent is released, the tube 57 can be slid over the tube 55 and rotated relative thereto so that the element 63 screws into, and helically interlocks with, the element 61 in a manner akin to a bolt screwing into a nut. In this way the driving portions 61, 63 are collapsible to a compact transport configuration and extensible to an elongate operative configuration for better engagement with the ground.

In this particular example, the upper element 55 has a shaped socket to receive and be driven by the handle 53 and that socket is bisected by a transverse through-hole 65. To install the anchor 51, it is first extended to its operative position and fitted with the handle 53. The spearhead 59 is pressed into the soil and the handle 53 is turned until the through-hole 65 is close to ground level. The handle 53 is then removed and a cable can then be passed through the hole 65 whereby the embedded portions of the anchor 51 can provide a convenient anchor point for securing other items. By way of example, a beach umbrella at risk of blowing away could be anchored, or items of value, or a compartment for storing items of value, could be tethered to the anchor. Conveniently, a cable passing through the hole 65 blocks the reinsertion of the handle 53 to prevent the unauthorised removal of the embedded portions of the anchor. The anchor 51 can be conveniently deployed in a variety of contexts, e.g. in the context of installing a marquee, or wherever similar anchorage is called for.

Similar anchorage may be employed in the context of a locker akin to the locker 1. In particular, when used to dig a hole (in line with the previously described method) in beach sand, this style of anchor has been found to produce a conveniently vertically-shaped hole and then to penetrate more deeply into the sand (relative to bladed augers) for a given amount of torque applied to the handle. Thus, in some settings, this style of anchor may be preferred over the bladed anchor assembly.

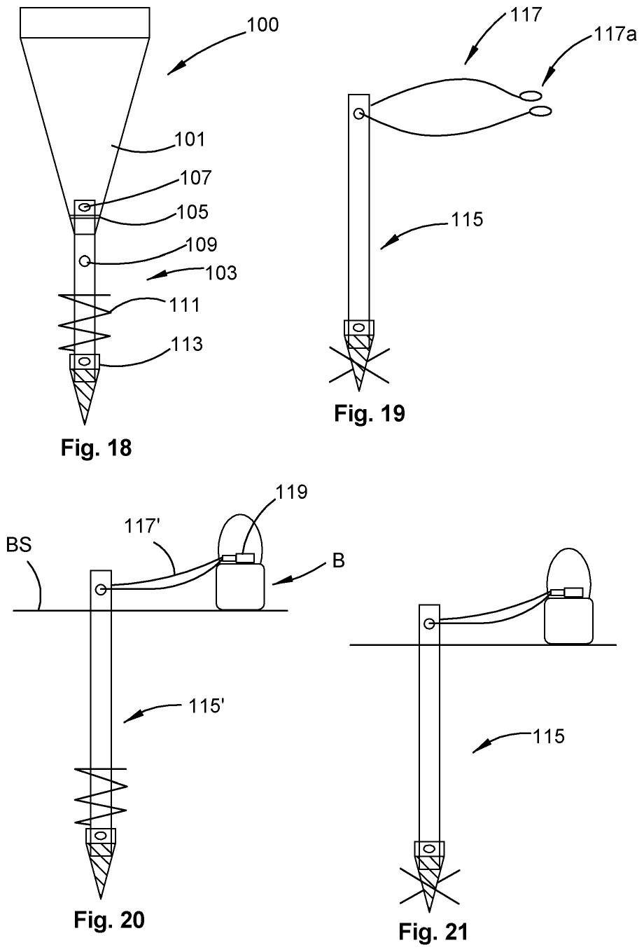

FIG. 18 illustrates a locker 100 comprising a compartment 101 and anchor 103 extendable from the compartment. The locker 100 comprises abutments by which the anchor 103 is captured, which in this example take the form of a washer 105 at the bottom of the compartment 101 and a pin or bolt 107 transversely bisecting a top end of the shaft of the anchor 103. A hole 109 bisects the anchor 103 and defines an alternative location for mounting the pin or bolt 107 to vary the extended length of the anchor 103. The anchor further comprises a coil auger 111 and an auger tip 113.

Optionally, the locker might be used as a garden safe to store a spare house key.

FIG. 19 illustrates a compartment-less anchor 115 comprising a bladed auger and fitted with a tether 117 taking the form of a length of cable having a respective eyelet 117a at each of its ends. The cable 117 is threaded through an eye at the top of the anchor. In combination with a padlock co-operable with the eyelets 117a, the anchor may be conveniently used to secure items of value such as a bicycle.

FIG. 20 illustrates a compartment-less anchor 115′ comprising a coil auger installed in beach sand BS and secured to a bag B via a tether 117′ and a padlock 119. FIG. 21 illustrates the anchor 115 securing a bag.

Advantageously, the locker 1 may be provided with a carry bag, e.g. a cylindrical bag, one end of which has an opening and a drawstring for closing the opening. A pair of shoulder straps may run from one end of the bag to the other.

Whilst various examples have been described, the invention is not limited to these examples. Rather, the invention is defined by the claims.

1-8. (canceled)

9. A locker comprising:
a lockable compartment; and
an anchor;
at least a portion of the compartment being tapered to penetrate particulate; and
the anchor being below the compartment and rotatable to pull the compartment at least partly into the particulate.

10. The locker of claim 9 wherein the anchor is retractable for storage.

11. The locker of claim 9 wherein an exterior of the compartment is round to impede the application of torque thereto.

12. The locker of claim 9 wherein the compartment is capable of rotation relative to the anchor to impede unauthorised reversal of the anchor.

13. The locker of claim 9 wherein the compartment is capable of pivoting about horizontal axes relative the anchor to impede loosening the anchor by applying horizontal force to a top of the compartment.

14. The locker of claim 13 wherein one of the compartment and the anchor defines a spherical surface co-operable with the other of the compartment and the anchor.

15. The locker of claim 9 wherein the compartment has an exterior and a top; and
below the top, at least most of the exterior is tapered.

16. The locker of claim 9 including a pivotally mounted lid.

17. The locker of claim 9 wherein an outer extent of the anchor is at a diameter not less than half a width of the compartment.

18. The locker of claim 9 wherein the anchor is telescopic.

19-24. (canceled)

25. The locker of claim 9 comprising an eye through which a shackle of a padlock is passable to lock the compartment.

26. (canceled)

27. The locker of claim 25 wherein
the padlock comprises a body;
the shackle comprises
an outward run running outwardly from the body;
an inward run having an end reversibly receivable in the body; and
outer shackle portion connecting the outward run to the inward run; and
the locker comprises
a stop;
a restraint;
an outer-installation space forward of the eye and rearward of the restraint;
an inward-installation space through which the inward run is movable to pass through the eye;
a body-installation space adjacent the stop to receive a portion of the body as the outer shackle portion is moved, whilst the inward run remains through the eye, into the outer-installation space;
a shackle-receiving space under the restraint and positioned to receive the shackle when the padlock is advanced from the body-installation space; and
a body-receiving space positioned in front of the stop for a portion of body to pivot, after said advancement and about the outer-run, into the body-receiving space;
the restraint being at a distance, less than a locked-length of the padlock, from the stop such that, when the padlock is locked after said pivoting, the shackle is trapped behind the restraint and the body is trapped in the body receiving space.

28. The locker of claim 27 comprising guarding portions positioned to run alongside the inward run and the outward run.

29. The locker of claim 27, comprising the padlock.

30. (canceled)

31. A method of installing a locker,
the locker comprising
a lockable compartment, and
an anchor below the compartment;
the method comprising turning the anchor to pull the compartment at least partly into particulate.

32. The method of installing a locker; claim 31 wherein
the locker comprises
a handle longer than the compartment is wide; and
the method comprises
turning the handle to screw the anchor into particulate; and
locking away, at least a portion of the handle, in the compartment to impede unauthorised unscrewing of the anchor.

33. (canceled)

34. The locker of claim 9 comprising a handle
for rotating the anchor to screw the anchor into particulate;
longer than the compartment is wide; and
reconfigurable between a first configuration, for rotating the anchor, and a second configuration in which the at least portion of the handle is to configured for receipt, and locking away, in the compartment to impede unauthorised unscrewing of the anchor.

35. The locker of claim 9 wherein the handle comprises parts
mutually connectable for the first configuration; and
mutually disconnectable for the second configuration; and
wherein the parts comprise
a hub mounted, or mountable, coaxial to the anchor; and
two handle portions connectable to, for rotating, the hub;
wherein at least one tie ties the parts together and is resiliently extensible to enable the parts to be mutually disconnected to form the second configuration.

36. The locker of claim 34 wherein the handle is, or is positionable, above the compartment; and
the locker includes a shaft for transmitting torque from the handle above the compartment to the anchor.

37. The locker of claim 35 wherein the anchor is hollow and has an inlet; and
the shaft and the anchor include features shaped to enable the shaft to be moved, relative to the anchor, between
a storage position in which the shaft is receivable within the anchor for storage; and
a transmission position for transmitting torque;
wherein the shaft has
a first end configured to engage, to transmit torque to, the anchor; and
a second end configured differently to the first end to pass through the inlet to enable the shaft to move into the anchor for storage.
